(19) United States
(12) Patent Application Publication
(10) Pub. No.: US 2025/0349231 A1
(43) Pub. Date: Nov. 13, 2025

(54) CONTENT BASED DYNAMIC SWITCH FOR NUMBER OF FOVEATION LEVELS IN VIDEO SEE-THROUGH

(71) Applicant: QUALCOMM Incorporated, San Diego, CA (US)

(72) Inventors: Saurabh AGGARWAL, Bengaluru (IN); Abhijeet DEY, Bengaluru (IN); Shrey Shailesh GADIYA, Bengaluru (IN)

(21) Appl. No.: 18/662,367

(22) Filed: May 13, 2024

(51) Int. Cl. G09G 3/00; G06T 3/40

(52) U.S. Cl. CPC G09G 3/001; G06T 3/40; G09G 2340/0407; G09G 2354/00

(57) ABSTRACT

Aspects presented herein may enable an extended reality (XR) headset (e.g., a UE) to use statistics and/or a saliency map to dynamically determine the number of foveation levels to be used for a display. In one aspect, a UE estimates a detail level specified by a periphery region of a display based on scene statistics and/or saliency. The UE determines a first set of foveation levels or a second set of foveation levels to be applied to the display based on the estimated detail level. The UE switches, based on the determination, to the first set of foveation levels or the second set of foveation levels if the display is applying a different set of foveation levels. The UE outputs a set of images or videos via the display based on the first or the second set of foveation levels.

### TECHNICAL FIELD

The present disclosure relates generally to image processing systems, and more particularly, to image processing involving extended reality (XR).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus estimates a detail level specified by a periphery region of a display based on at least one of scene statistics or saliency. The apparatus determines one of a first set of foveation levels or a second set of foveation levels to be applied to the display based on the estimated detail level, where the first set of foveation levels is applied if the estimated detail level is below a predetermined threshold or a first threshold, where the second set of foveation levels is applied if the estimated detail level is above the predetermined threshold or a second threshold. The apparatus switches, based on the determination, to the first set of foveation levels or the second set of foveation levels if the display is applying a different set of foveation levels. The apparatus outputs a set of images or videos via the display based on the first set of foveation levels or the second set of foveation levels.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example communication between a server, a base station, and one or more UEs in accordance with various aspects of the present disclosure.

FIG. 5 is a diagram illustrating an example of a list of components in an extended reality (XR) headset in accordance with various aspects of the present disclosure.

FIG. 6 is a diagram illustrating an example XR headset with multiple levels of foveation in accordance with various aspects of the present disclosure.

FIG. 7 is a flow diagram illustrating an example of an XR headset with a foveation level control module for foveated sensors in accordance with various aspects of the present disclosure.

FIG. 8 is a flow diagram illustrating an example of an XR headset with a foveation level control module for non-foveated sensors in accordance with various aspects of the present disclosure.

FIG. 9 is a diagram illustrating an example implementation of a foveation level control module in accordance with various aspects of the present disclosure.

FIG. 10A is a diagram illustrating an example weight map distribution for a fovea region centered in the frame in accordance with various aspects of the present disclosure.

FIG. 10B is a diagram illustrating an example weight map distribution for a fovea region that is not centered in the frame in accordance with various aspects of the present disclosure.

FIG. 11 is a diagram illustrating an example of configuring a foveation level control module with a threshold level hysteresis loop to provide stability while switching number of foveation levels in accordance with various aspects of the present disclosure.

FIG. 12A is a diagram illustrating an example weight versus distance plot for normal/bright lighting in accordance with various aspects of the present disclosure.

FIG. 12B is a diagram 1200B illustrating an example weight versus distance plot for scotopic vision in accordance with various aspects of the present disclosure.

FIG. 13 is a diagram illustrating an example dataflow of maintaining a complete synchronization between a sensor and an image signal processor (ISP) of an XR headset in accordance with various aspects of the present disclosure.

FIG. 14 is a flowchart of a method of image processing.

FIG. 15 is a flowchart of a method of image processing.

FIG. 16 is a diagram illustrating an example of a hardware implementation for an example apparatus and/or network entity.

### DETAILED DESCRIPTION

Aspects presented herein may improve the overall performance of extended reality (XR) headsets. Aspects presented herein may enable an XR headset (or its component(s)/processor(s)) to use auto focus and/or brightness statistics and/or a saliency map to estimate the level of details specified in the periphery (of at least one display) and determine the number of foveation levels specified for the periphery (or the display). The XR headset (or its component(s)/processor(s)) may perform the weight map and the threshold adjustment based on lighting conditions, eye/head movements and/or focus state of system. Aspects presented herein also provide a dataflow to ensure a complete sensor-image signal processor (ISP) synchronization and no frame-drops and no latency when dynamically changing number of foveation levels. Aspects presented here may provide power, bandwidth, and computing resource optimization for video see-through (VST) use-cases based on the scene-content without impact to the perceptual image quality (IQ).

Sensor and ISP foveation is used in XR to reduce power and meet increasing demand for resolution/frame per second (FPS) in VST. Two and three levels of foveation have been used to provide a gradual change in resolution as the user moves from the fovea region. Three levels of foveation consumes more power and bandwidth as compared to the two levels of foveation. Currently, the number of foveation levels is fixed by original equipment manufacturers (OEMs) based on IQ versus power-trade-off. There is a desire to dynamically determine the number of foveation levels sufficient for a particular scene and switch it accordingly. Information from an ISP or Saliency map are calculated to extract details present in the periphery, and based on the level of details in the periphery, a determination is made whether two foveation levels are sufficient for maintaining IQ or whether three foveation levels are specified. Auto focus statistics, brightness statistics, and/or saliency detection statistics are used to estimate levels of details present in the periphery.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

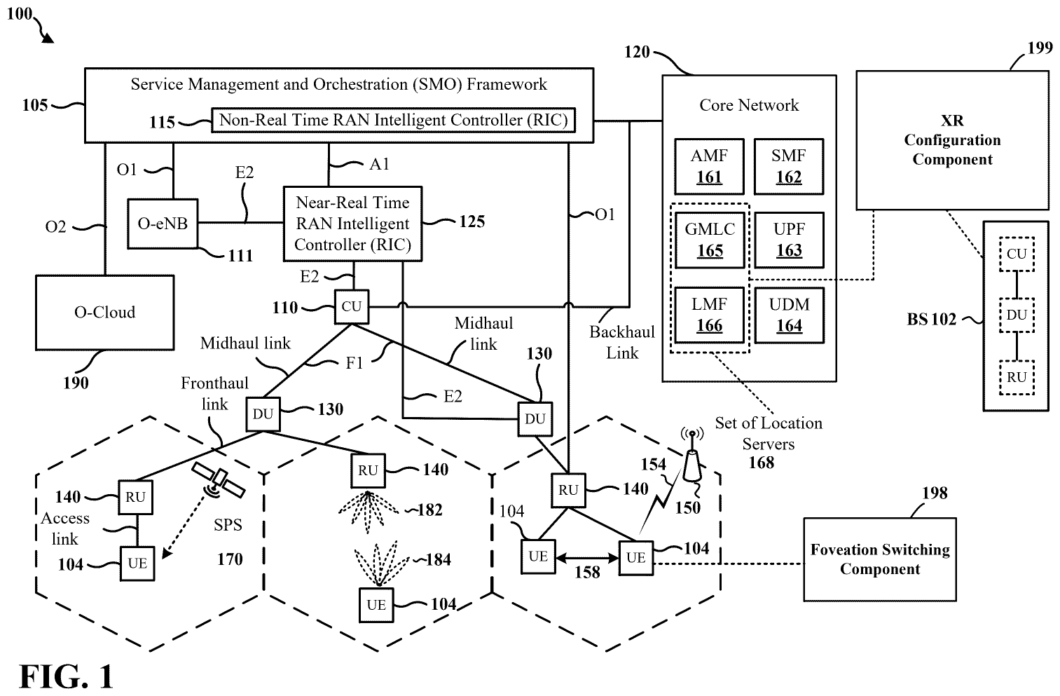

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (is a trademark of the Wi-Fi Alliance) based on the Institute of Electrical and Electronics Engineers (IEEE) 802.11 standard, LTE, or NR. The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 (e.g., an extended reality (XR) headset) may have a foveation switching component 198 that may be configured to estimate a detail level specified by a periphery region of a display based on at least one of scene statistics or saliency; determine one of a first set of foveation levels or a second set of foveation levels to be applied to the display based on the estimated detail level, where the first set of foveation levels is applied if the estimated detail level is below a predetermined threshold or a first threshold, where the second set of foveation levels is applied if the estimated detail level is above the predetermined threshold or a second threshold; switch, based on the determination, to the first set of foveation levels or the second set of foveation levels if the display is applying a different set of foveation levels; and output a set of images or videos via the display based on the first set of foveation levels or the second set of foveation levels. In certain aspects, the base station 102 or the one or more location servers 168 may have an XR configuration component 199 that may be configured to provide (pre-) configuration(s) related to XR for the UE 104.

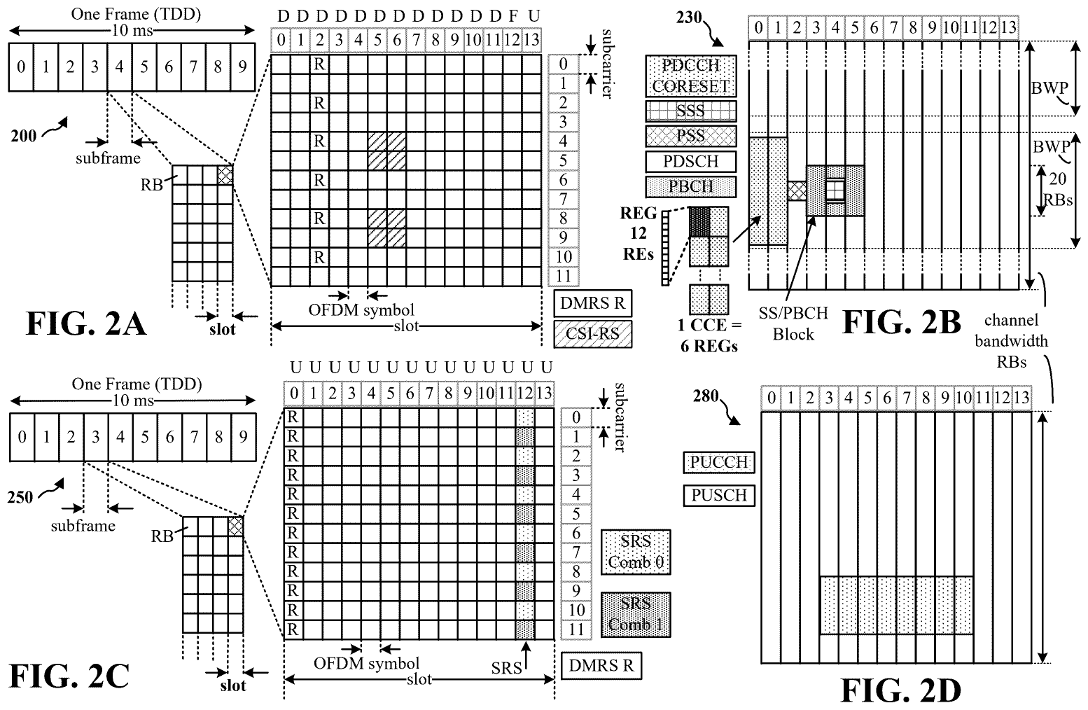

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

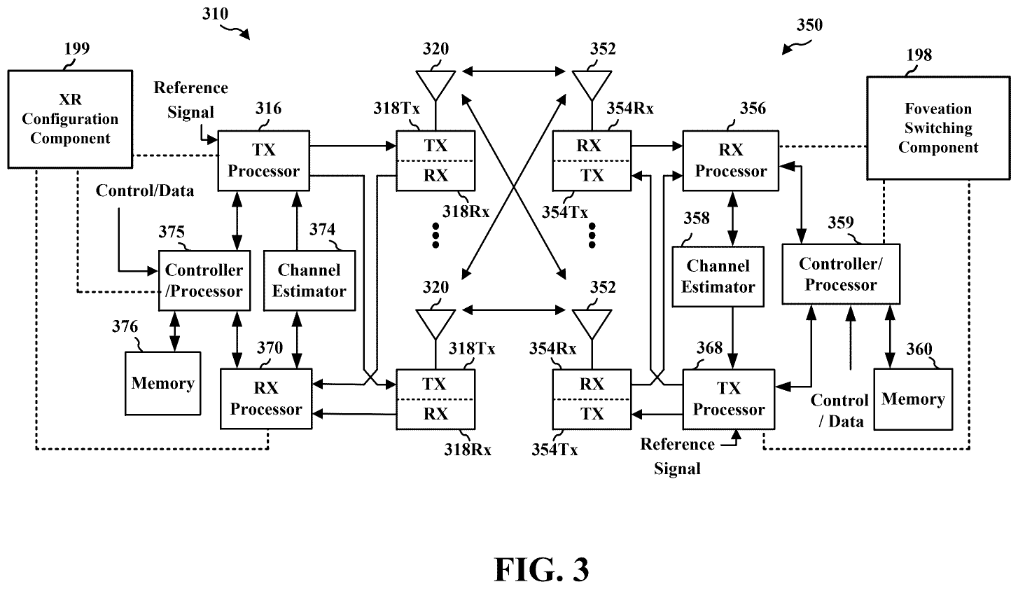

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization. The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the foveation switching component 198 of FIG. 1.

At least one of the TX processor 316, the RX processor 370, and the controller/processor 375 may be configured to perform aspects in connection with the XR configuration component 199 of FIG. 1.

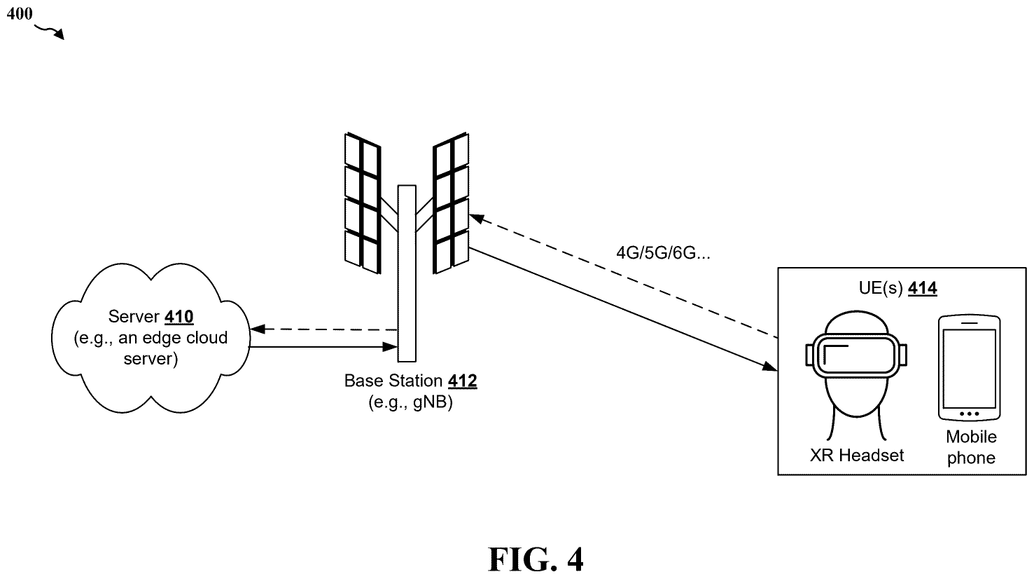

FIG. 4 is a diagram 400 illustrating an example communication between a server 410, a base station 412, and one or more UEs 414 in accordance with various aspects of the present disclosure. With improvements to the transmission (Tx) and reception (Rx) speed, latency, and/or the reliability of wireless communications (e.g., 4G LTE, 5G NR, 6G, etc.) over the last few years, various devices and applications have been designed and configured to take advantage of these improvements. As such, some devices/applications may have very tight/strict specifications for wireless communication. For example, extended reality (XR) applications and certain mobile devices (collectively as UEs) may have very tight specifications for latency and power, such as specifying a packet delay budget to be less than 10 milliseconds (ms) and/or a power consumption to be less than 1 Watt (W), etc. For purposes of the present disclosure, XR may refer to technologies that combine the physical and digital worlds, creating immersive and interactive environments for users. XR may be an umbrella term that encompasses virtual reality (VR), augmented reality (AR), and/or mixed reality (MR).

In some scenarios, XR may also be associated/implemented with video see-through (VST) technology to seamlessly blend the physical and virtual worlds to provide users with an immersive and interactive experience. In VST, a camera may be configured to capture a digital video image (which may be referred to as a “frame”) of the real world and transfers it to a graphics processor in real-time. Then, the graphics processor (which may also be referred to as an “image signal processor (ISP)”) may combine the video image feed with computer-generated images (e.g., a virtual content) and displays it on a screen (e.g., a screen on an XR headset). As such, VST may refer to the integration of live video feed from a user's perspective into the XR environment. VST may be employed in various applications across industries, including gaming, education, healthcare, and industrial training.

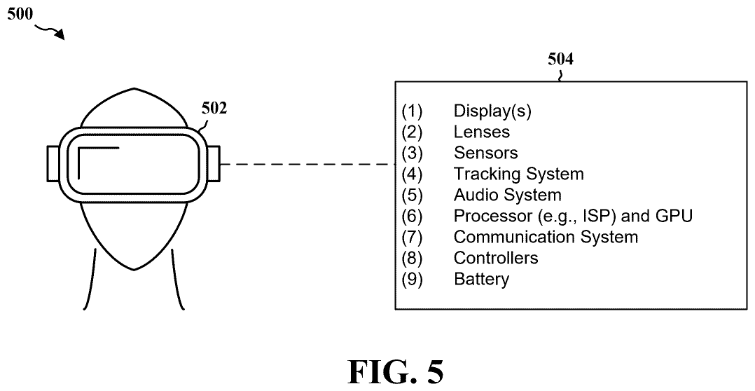

FIG. 5 is a diagram 500 illustrating an example of a list of components in an XR headset in accordance with various aspects of the present disclosure. As shown at 504, an XR headset 502 (which may also be referred to as a UE for purposes of the present disclosure) may include one or more of the following components:
(1) Display(s): an XR headset may include one or more high-resolution displays for rendering virtual and/or augmented content. These displays may be positioned close to the user's eyes to create an immersive field-of-view (FOV).
(2) Lenses: an XR headset may include a set of lenses that is used to focus and shape the light coming from the display(s), enhancing the quality of the virtual and/or augmented images. The lenses may also be used for determining the field of view and minimizing distortion.
(3) Sensors: an XR headset may include various sensors to track the user's movements and positions. Sensors may include an inertial measurement unit (IMU), an accelerometer, a gyroscope, a magnetometer, and sometimes one or more external tracking systems (e.g., external cameras and/or sensors placed in the environment).
(4) Tracking System: an XR headset may include an internal and/or an external tracking system that is capable of monitoring the position and the orientation of the XR headset.
(5) Audio System: an XR headset may include a built-in audio system or a headphone jack to provide audio to the user.
(6) Processor (e.g., ISP) and/or GPU: an XR headset may include at least one processor and/or graphics processing unit (GPU) to handle the rendering of complex virtual environments or augmentations.
(7) Communication System: an XR headset may include a set of wired and/or wireless connectivity options to connect the XR headset to external devices, networks, or controllers, which may include USB ports, Bluetooth®, 4G/5G wireless network, and/or Wi-Fi capabilities, etc.
(8) Controllers: an XR headset may include a set of controllers that enables the user to interact with the virtual environment. These controllers may include buttons, triggers, and sometimes haptic feedback for a more immersive experience.
(9) Battery: an XR headset may include a set of rechargeable batteries to power the XR headset during use.

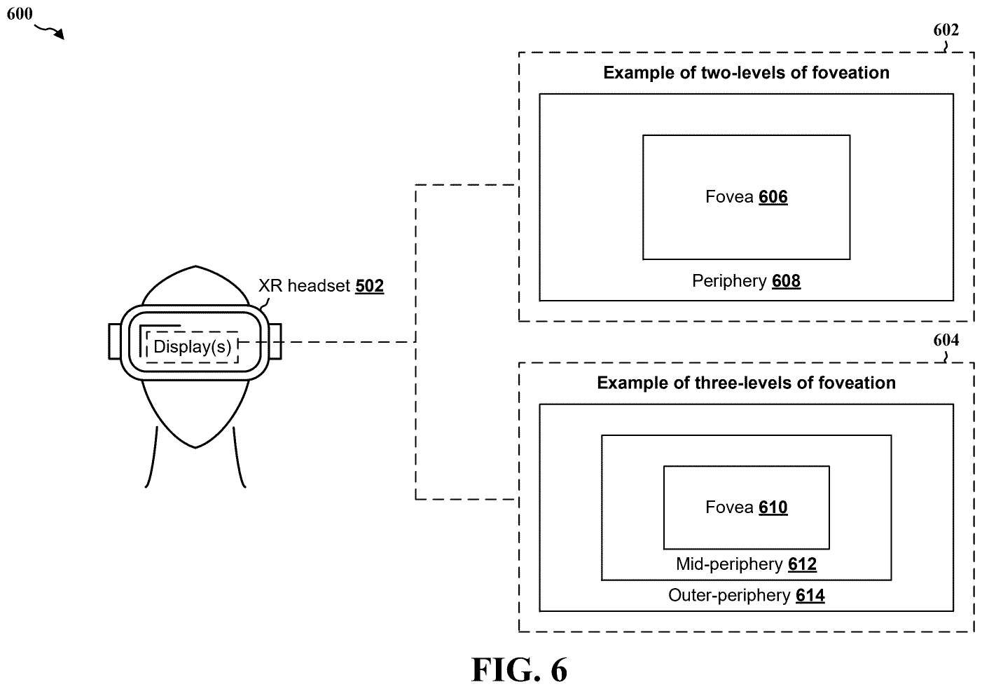

FIG. 6 is a diagram 600 illustrating an example XR headset with multiple levels of foveation in accordance with various aspects of the present disclosure. In some implementations, sensor and/or ISP foveation may be used in XR to reduce the power consumption of the XR headset and/or to meet the increasing demand/specification for resolution/frame per second (FPS) in VST.

In the context of XR or XR headsets, foveation may refer to a rendering/displaying technique that optimizes the allocation of computational resources, such as processing/ISP power and graphics rendering, by focusing higher detail and resolution on the part of the display where the user is currently looking. Such configuration is based on mimicking the natural behavior of the human eye, which perceives the central portion of the visual field in higher detail than the peripheral areas (which may also be referred to as the “periphery”). The term “fovea” may refer to the central part of the retina that is responsible for sharp and detailed vision. Foveation may take the advantage that our visual acuity is highest at the center of our gaze and decreases towards the periphery. By dynamically adjusting the level of detail in different regions of the display based on the user's gaze, foveated rendering aims to improve the efficiency of rendering and reduce the overall computational workload and power consumption at the XR headset. In some examples, eye-tracking sensors may be used in an XR headset for detecting which direction the user is looking. Then, the XR headset (or the processor/controlling system of the XR headset) may allocate more processing power to transmit, process, and/or render the region of the display in which the user is looking with higher resolution and detail, while reducing the detail in the peripheral regions.

There may be different configurations for foveation levels that are used for XR headsets. For example, as shown at 602, two-levels of foveation may be used/configured for the XR headset 502, where the display(s) of the XR headset 502 may include two regions: a fovea region 606 with a native (e.g., higher) resolution and a peripheral region 608 with a downscaled (DS)/reduced (e.g., lower) resolution. In some examples, the DS ratio for the peripheral region 608 compared to the fovea region 606 may be four (4), which may be denoted as “DS4” (e.g., the resolution of the fovea region 606 is four times higher than the peripheral region 608). This is a first order approximation of human vision system (HVS) and provides reasonable VST experience while keeping power and bandwidth consumption in pixel transmission, processing, and rendering low.

In another example, as shown at 604, three-levels of foveation may be used/configured for the XR headset 502, where the display(s) of the XR headset 502 may include three regions: a fovea region 610 with a native (e.g., higher) resolution, a mid-peripheral region 612 with DS by X₁, and an outer-peripheral region 614 with DS by X₂, where X₂ is greater than X₁ (X₂>X₁). For example, if X₁₌₂ and X₂₌₄ (which may be denoted as “DS2” and “DS4,” respectively), it may indicate that the resolution of the fovea region 606 is two times higher than the mid-peripheral region 612 and four times higher than the outer-peripheral region 614. Such configuration may provide a gradual change in resolution as users move/look away from the fovea region and hence may be more consistent with HVS. However, the three-levels of foveation may consume more power and bandwidth as the XR headset 502 may be specified to transmit, process, and render higher number of pixels as compared to the two-levels of foveation.

As an illustration, assuming the display(s) of the XR headset 502 is capable of rendering a full FOV with 36 megapixels (MP) (e.g., 6,000 pixels×6,000 pixels=36,000,000 pixels). For the two-levels of foveation as shown at 602, if the size of the fovea region 606 is 1/9th of the full FOV, it may have a resolution of 4 MP (e.g., 2000×2000 or 36/9). For the peripheral region 608, the full FOV at DS4 resolution may be 2.25 MP (e.g., 1500×1500). Then, the effective/total number of pixels for the two-levels of foveation may be 6.25 MP (e.g., 4 MP+2.25 MP). On the other hand, for the three-levels of foveation as shown at 604, if the size of the fovea region 610 is 1/9th of the full FOV, it may have a resolution of 4 MP (e.g., 2000×2000 or 36/9). If the size of the mid-peripheral region 612 is 4/9th of full FOV at DS2 resolution, it may have a resolution of 4 MP (e.g., 2000×2000). If the size of the outer-peripheral region 614 has a full FOV at DS2 resolution, it may have a resolution of 2.25 MP (e.g., 1500×1500). Then, the effective/total number of pixels for the three-levels of foveation may be 10.25 MP (e.g., 4 MP+4 MP+2.25 MP). Based on these calculations, it may be observed that the three-levels of foveation may specify approximately 64% more pixels to be transmitted, processed, and rendered compared to the two-levels of foveation, and hence may also consume more power.

For most XR headsets, the number of foveation levels supported by the XR headsets may be fixed by their manufacturers (e.g., their original equipment manufacturers (OEMs)) at the beginning of the use based on image quality (IQ) and/or power trade-off considerations. In some scenarios, some OEMs may specify the three-levels of foveation for better IQ, but this may come at a cost of higher power and bandwidth consumption as described in connection with FIG. 6. In addition, most XR headsets are not capable of dynamically determining the number of foveation levels sufficient for a particular scene and switch the foveation level accordingly. As such, in most cases even if two-levels of foveation are sufficient to maintain the human vision IQ, most XR headsets may still be specified to operate on the three-levels of foveation, which may lead to unwanted wastage of power and bandwidth.

Aspects presented herein may improve the overall performance of XR headsets by enabling the XR headsets to determine the switching for number of levels of foveation based on the IQ and/or the power. For example, aspects presented herein may enable an XR headset to determine whether to switch between different levels of foveation based on a set of criteria, where the set of criteria may be configurable to cater to a wide range of ambient conditions and user-movements. Aspects presented herein may be robust to ensure a proper sensor-ISP synchronization when XR headsets are switching the foveation levels without any frame-drop. As such, aspects presented herein are capable of providing a good VST experience while optimizing power and/or bandwidth consumption at XR headsets.

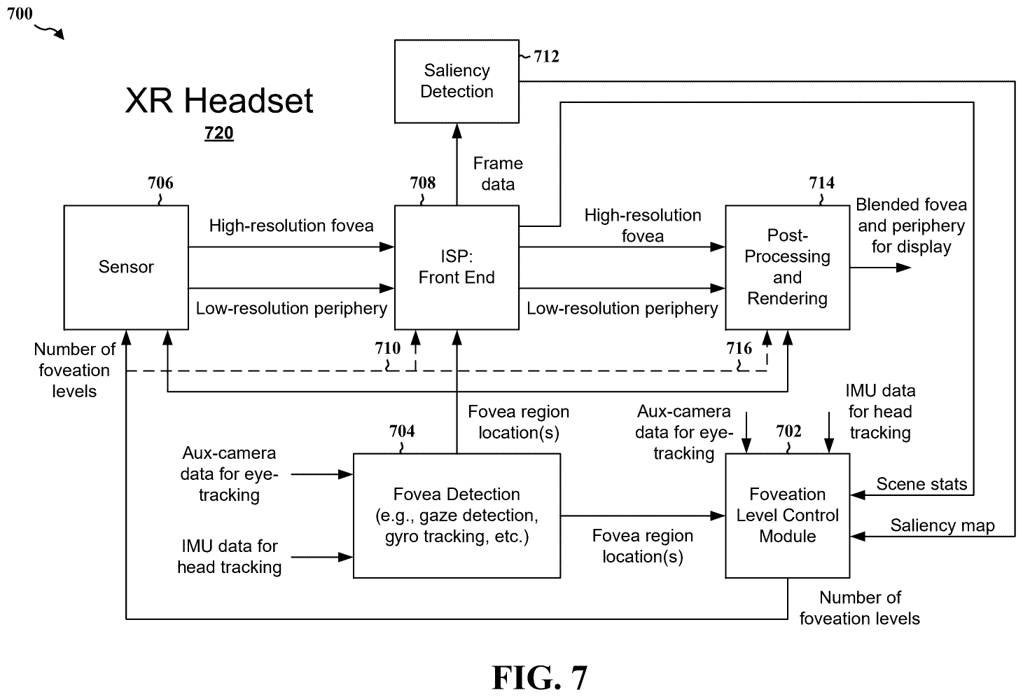

FIG. 7 is a flow diagram 700 illustrating an example of an XR headset with a foveation level control module for foveated sensors in accordance with various aspects of the present disclosure. As shown at 702, in one aspect of the present disclosure, a foveation level control module may be configured to determine and/or control the number of foveation levels to be used for one or more displays of an XR headset 720 based on a set of inputs, such as: (1) fovea region location(s) (e.g., obtained from a fovea detection module based on gaze detection and/or gyro tracking, etc. as shown at 704), (2) auxiliary (aux)-camera data related to eye tracking, (3) IMU data related to head tracking, (4) a set of scene statistics (stats) (e.g., obtained from an ISP at a front end), and (5) a saliency map (e.g., obtained from a saliency detection module). Then, the foveation level control module may output the determined number of foveation levels to at least one sensor (e.g., at least one camera). Also, prior to the determination of the number of foveation levels to be used for (e.g., specified by) one or more displays of an XR headset 720, the one or more displays of the XR headset 720 may be configured to apply a default/initial set of foveation levels specified for the one or more displays of the XR headset 720.

As shown at 706, after the at least one sensor (which may be referred to as the foveated sensor) receives the determined number of foveation levels from the foveation level control module (e.g., two-levels of foveation, three-levels of foveation, X-levels of foveation, etc.), the at least one sensor may foveate the sensor data directly (e.g., foveating the images/videos from the at least one camera). In some examples, the sensor data may also be referred to as a frame or a set of frames. Then, the at least one sensor may output the foveated sensor data (e.g., the high-resolution image/video for the fovea region and the reduced/low-resolution image/video for the peripheral region) to an image signal processor (ISP) (e.g., a front end processor).

As shown at 708, based on the foveated sensor data (e.g., the high-resolution fovea data and the low-resolution periphery data of a frame) and the fovea region location(s) (e.g., from the fovea detection module as shown at 704), the ISP may determine frame data and output it to a saliency detection module, and the ISP may also determine a set of scene statistics (or an updated set of scene statistics) and output it to the foveation level control module. The ISP may also forward/output the foveated sensor data to a post-processing and rendering module. In some implementations, as shown at 710, the foveation level control module may also output the determined number of foveation levels to the ISP for the ISP to generate corresponding configurations related to processing or displaying the foveation level.

As shown at 712, after receiving the frame data from the ISP, the saliency detection module may generate a saliency map (or an updated saliency map), and output it to the foveation level control module.

As shown at 714, based on the foveated sensor data (e.g., the high-resolution fovea data and the low-resolution periphery data) and the fovea region location(s) (e.g., from the fovea detection module as shown at 704), the post-processing and rendering module may process and render the blended fovea and periphery data for display (e.g., via one or more displays) as described in connection with FIG. 6. Depending on implementations, the post-processing and rendering module may be one module or multiple modules (e.g., a post-processing module and a rendering module). For example, the post-processing module (or the post-processing part of the post-processing and rendering module) may be configured to perform additional/further processing on the foveated data (e.g., denoising, edge enhancement, tone mapping, and/or warping, etc.) and the rendering module (or the rendering part of the post-processing and rendering module) may be configured to blend the fovea and periphery data and render it for display. (e.g., via one or more displays). In some examples, for VST technology, there may be a memory hop (e.g., a double data rate (DDR) hop, a random access memory (RAM) hop, etc.) between a post-processing module and a graphics processing unit (GPU) and/or between a GPU and a display. For example, an example VST pipeline may be configured to be: sensor(s)->ISP front-end->ISP post-processing->additional post-processing and composition inside a GPU->rendering on a display. In such a configuration, there may be a DDR hop between (1) ISP front-end and ISP post-processing, (2) ISP post-processing and GPU, and/or (3) Between GPU and display processing unit (DPU) (if available).

In some implementations, as shown at 716, the foveation level control module may also output the determined number of foveation levels to the post-processing and rendering module for the post-processing and rendering module to adjust its configurations accordingly. In other words, the XR headset 720 may apply the determined number of foveation levels to one or more of its displays, such as to a set of images or videos.

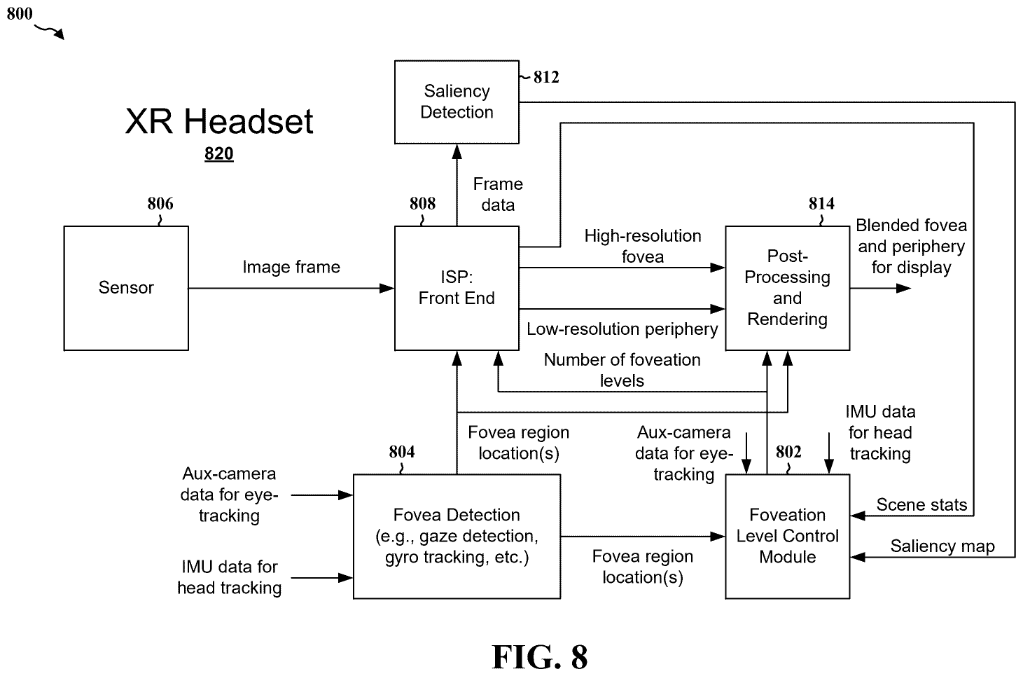

FIG. 8 is a flow diagram 800 illustrating an example of an XR headset with a foveation level control module for non-foveated sensors in accordance with various aspects of the present disclosure. As shown at 802, a foveation level control module may be configured to determine and/or the number of foveation levels to be used for one or more displays of an XR headset 820 based on a set of inputs, such as: (1) fovea region location(s) (e.g., obtained from a fovea detection module based on gaze detection and/or gyro tracking, etc. as shown at 804), (2) auxiliary (aux)-camera data related to eye tracking, (3) IMU data related to head tracking, (4) a set of scene statistics (stats) (e.g., obtained from an ISP at a front end), and (5) a saliency map (e.g., obtained from a saliency detection module). Then, the foveation level control module may output the determined number of foveation levels to an ISP and/or a post processing and rendering module (note the post processing and rendering module may also be separate modules such as a post processing module and a rendering module). Also, prior to the determination of the number of foveation levels specified by one or more displays of an XR headset 820, the one or more displays of the XR headset 820 may be configured to apply a default/initial set of foveation levels specified for the one or more displays of the XR headset 820.

As shown at 806, the at least one sensor may output sensor data (e.g., frame(s)) that has not been foveated to the ISP. This at least one sensor may be referred to as the non-foveated sensor for purposes of the present disclosure as it is not configured to foveate the sensor data.

As shown at 808, based on the determined number of foveation levels, the ISP may foveate the sensor data from at least one sensor at the ISP (e.g., into high-resolution fovea data and the low-resolution periphery data). Similarly, based on the foveated sensor data/the determined number of foveation levels and the fovea region location(s) (e.g., from the fovea detection module as shown at 804), the ISP may determine frame data and output it to a saliency detection module, and the ISP may also determine a set of scene statistics (or an updated set of scene statistics) and output it to the foveation level control module. The ISP may also forward/output the foveated sensor data to a post-processing and rendering module (or to a post-processing module and/or a rendering module).

As shown at 812, after receiving the frame data from the ISP, the saliency detection module may generate a saliency map (or an updated saliency map), and output it to the foveation level control module.

As shown at 814, based on the foveated sensor data (e.g., from the ISP) and/or the determined number of foveation levels (e.g., from the foveation level control module), and also based on the fovea region location(s) (e.g., from the fovea detection module as shown at 804), the post-processing and rendering module may process and render the blended fovea and periphery data for display (e.g., via one or more displays) as described in connection with FIG. 6. For example, depending on implementations, the post-processing and rendering module may be one module or multiple modules (e.g., a post-processing module and a rendering module). For example, the post-processing module (or the post-processing part of the post-processing and rendering module) may be configured to perform additional/further processing on the foveated data (e.g., denoising, edge enhancement, tone mapping, and/or warping, etc.) and the rendering module (or the rendering part of the post-processing and rendering module) may be configured to blend the fovea and periphery data and render it for display. (e.g., via one or more displays). In other words, the XR headset 820 may apply the determined number of foveation levels to one or more of its displays, such as to a set of images or videos.

As described in connection with FIGS. 7 and 8, a foveation level control module may be implemented at an XR headset to decide whether to switch between different levels of foveation. Then, the output of this foveation level control module may be used either by a sensor or by an ISP depending on where data/frame is being foveated, i.e., by the sensor in the case of foveated sensors as described in connection with FIG. 7 or by the ISP in the case of non-foveated sensors as described in connection with FIG. 8.

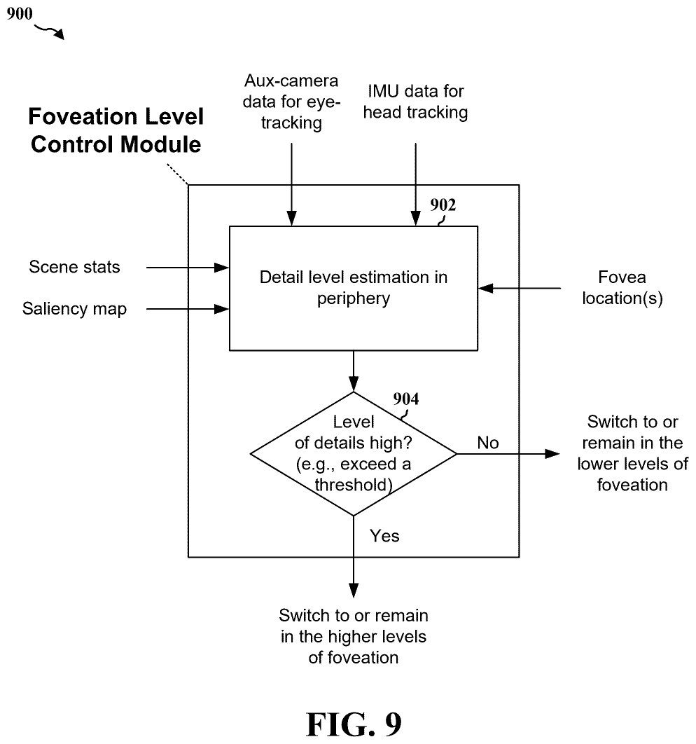

FIG. 9 is a diagram 900 illustrating an example implementation of a foveation level control module in accordance with various aspects of the present disclosure. As shown at 902 of the diagram 900, after the foveation level control module described in connection with FIGS. 7 and 8 receives (1) fovea region location(s), (2) aux-camera data related to eye tracking, (3) IMU data related to head tracking, (4) a set of scene statistics, and (5) a saliency map from various modules, the foveation level control module may estimate the detail level specified for the peripheral region as shown by FIG. 6. In some implementations, the foveation level control module may be configured to calculate a weighted sum of the statistics (i.e., the scene statistics) and/or a saliency map from the ISP and/or the saliency map to extract or identify the level of details presented in the periphery.

Then, as shown at 904, based on the extracted/identified level of details in the periphery, the foveation level control module may decide whether current level of foveation used by the XR headset is sufficient to maintaining the image quality (IQ) and/or whether a higher/lower of foveation is specified to improve the IQ or the power consumption. For example, assuming that the XR headset supports both the two-levels of foveation and three-levels of foveation as described in connection with FIG. 6, there may be four possible cases. First, if three-levels of foveation are currently being used and the extracted/identified level of details in the periphery is less (e.g., below a detail level threshold), the foveation level control module may decide to switch to two-levels of foveation (e.g., to improve power consumption). Second, if three-levels of foveation are currently being used and the extracted/identified level of details in the periphery is high (e.g., above a detail level threshold), the foveation level control module may decide to stick to/maintain three-levels of foveation. Third, if two-levels of foveation are currently being used and the extracted/identified level of details in the periphery is less (e.g., below a detail level threshold), the foveation level control module may decide to stick to/maintain two-levels of foveation. Fourth, if two-levels of foveation are currently being used and the extracted/identified level of details in the periphery is high (e.g., above a detail level threshold), the foveation level control module may decide to switch to three-levels of foveation (e.g., to improve IQ). Note while the example in FIG. 9 uses two-levels and three-levels of foveation for illustration, aspects presented herein may extend to any number of foveation levels (e.g., four-levels of foveation, five-levels of foveation, X-levels of foveation, etc.).

As described in connection with FIGS. 7 and 8, the foveation level control module may be configured to estimate the detail level specified by the peripheral region(s) based at least in part on a set of scene statistics and/or a saliency map. In one example, auto focus (e.g., contrast, sharpness, etc.) and/or brightness statistics may be used for the set of scene statistics for contrast-based auto-focus algorithms. For example, there may be a set of configurable number of grid statistic values (e.g., 48, 64, etc.) where each grid statistic value may indicate a level of contrast (or details) presented in that image region. In some examples, the saliency detection (e.g., the saliency map) may provide another set of statistics to indicate salient feature(s) and/or object(s) in a scene. This set of statistics may be a set of grid-based statistics. In some examples, the saliency map may be a pixel-wise map, where there may be a saliency value for each pixel. For example, wij and Sij discussed below may refer to saliency value of pixel at location (i, j) and weight assigned to the saliency value of this pixel. In one aspect of the present disclosure, the foveation level control module may be configured to use the contrast/sharpness/brightness statistics and the set of grid-based statistics from the saliency detection (which may be referred to as the “saliency statistics” and/or the “saliency map statistics” for purposes of the present disclosure), independently or in combination, to estimate the level of details presented in the periphery as described in connection with 902 of FIG. 9. Then, as described in connection with 904 of FIG. 9, the foveation level control module may use details presented in/estimated for the periphery to determine if a switch is specified between different levels of foveation. For example, as described in connection with FIG. 9, if the level of details presented in the periphery is low, the foveation level control module (or the XR headset) may switch the display(s) of the XR headset to use lower levels of foveation to save power and bandwidth.

In some implementations, the foveation level control module may be configured to calculate/use a weighted sum of the contrast/sharpness/brightness statistics and/or the saliency statistics obtain a single value indicator indicating the level of details presented in a scene. The weight for each grid statistic value may be determined based on its distance from the fovea center. The more the distance from the fovea center, the lower the weight associated with that grid statistic. Weights inside the fovea region/boundary may be set to zero (0) as just details in the periphery may be specified to be considered. In one example, the estimated level of details (D) may be calculated based on:

$$D = \frac{{\sum }_{i} {\sum }_{j} wij \times Sij}{{\sum }_{i} {\sum }_{j} wij}$$

where Sij is grid-statistic value located at (i, j) and wij is the associated weight with that grid-statistic value. S may be the BAF statistics, the saliency statistics, or a combination of both.

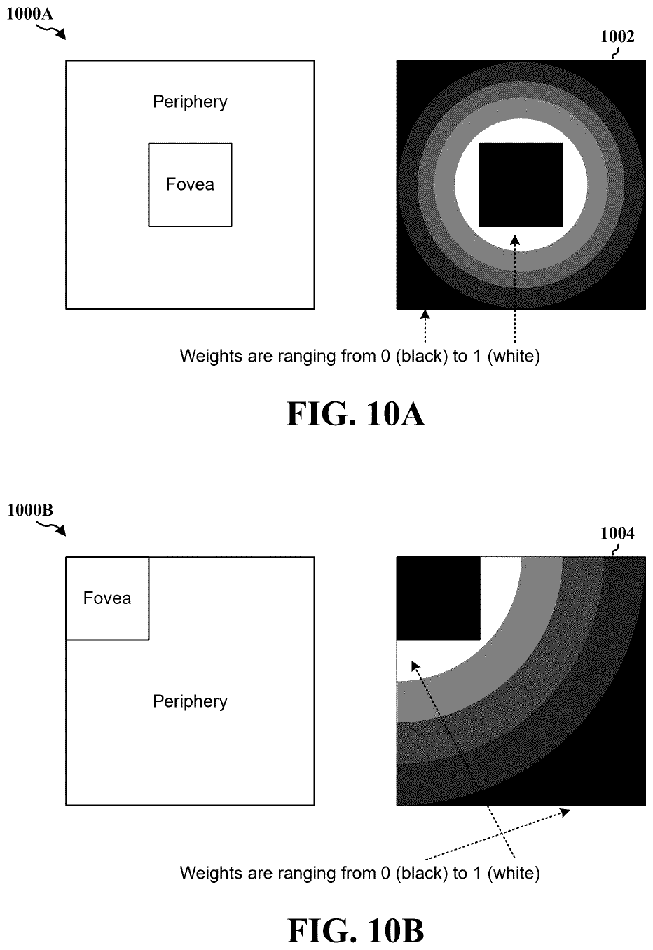

FIG. 10A is a diagram 1000A illustrating an example weight map distribution for a fovea region centered in the frame in accordance with various aspects of the present disclosure. A black and white image may be configured to show how weights are distributed throughout an image based on the location of the fovea, where the weights may range from zero (e.g., for black) to one (e.g., for white). The grey region(s) between the black and white may have the weights that is greater than zero and smaller than one (0<grey region(s)<1), and a higher weight may indicate a higher contribution to the detail level estimation. For example, as shown at 1002, if the fovea region is at the center of a frame, then areas closer to the center of the frame may be assigned with a higher weight (e.g., a value closer to 1 or equal to 1). On the other hand, areas that are further away from the center of the frame may be assigned with a lower weight (e.g., a value closer to 0 or equal to 0). Then, the foveation level control module may use this weight map for estimating the detail level specified in the periphery.

FIG. 10B is a diagram 1000B illustrating an example weight map distribution for a fovea region that is not centered in the frame (e.g., an off-centered fovea region) in accordance with various aspects of the present disclosure. In this example, as shown at 1004, if the fovea region is at the top-left corner of a frame, then areas closer to the top-left corner of the frame may be assigned with a higher weight (e.g., a value closer to 1 or equal to 1). On the other hand, areas that are further away from the top-left corner of the frame, such as the bottom-right corner of the frame, may be assigned with a lower weight (e.g., a value closer to 0 or equal to 0). Similarly, the foveation level control module may use this weight map for estimating the detail level specified in the periphery.

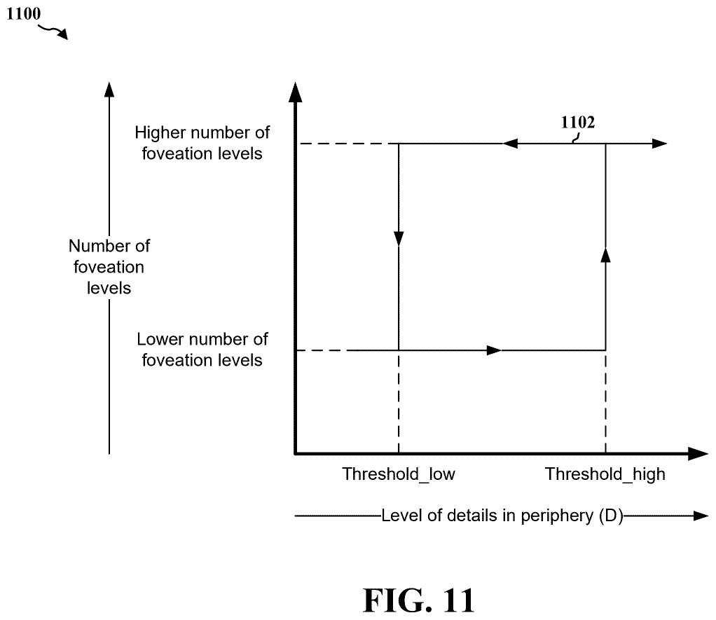

FIG. 11 is a diagram 1100 illustrating an example of configuring a foveation level control module with a threshold level hysteresis loop to provide stability while switching number of foveation levels in accordance with various aspects of the present disclosure. In another aspect of the present disclosure, to avoid a foveation level control module from performing constant/frequency switching between different foveation levels (e.g., when the estimated detail level specified by the periphery is close to the detail level threshold described in connection with FIG. 9), the foveation level control module may be configured to compare the estimated level of details for the periphery (D) against a set of configurable detail level thresholds to determine whether to switch the number of foveation levels. For example, if the estimated detail level is greater than the detail level threshold (D>detail level threshold), it means that the level of details specified is high, and the foveation level control module is configured to use or switch to a higher level of foveation, whereas if the estimated detail level is less than the detail level threshold (D<detail level threshold), it means that the level of details specified is low, and the foveation level control module is configured to use or switch to a lower level of foveation. Thus, if the estimated detail level is near the detail level threshold and is fluctuating between above the detail level threshold and below the detail level threshold, it might cause the foveation level control module to switch between different foveation levels constantly.

Accordingly, as shown at 1102, for providing stability in determining whether to switch to a different foveation level, the foveation level control module may be further implemented with a threshold level hysteresis loop, where this threshold level hysteresis loop may include at least a high threshold (threshold_high) and a low threshold (threshold_low). Thus, when lesser foveation levels are being used and if the estimated detail level is greater than the high threshold (D>threshold_high), the foveation level control module may switch to a higher level of foveation. On the other hand, when higher levels of foveation are being used and if the estimated detail level is less than the low threshold (D<threshold_low), the foveation level control module may switch to a lower level of foveation. If the estimated detail level is between the high threshold and low threshold, the foveation level control module may maintain the current foveation level used.

In some implementations, as an alternative or to further increase the stability in switching between different foveation levels, a frame level hysteresis may be added to the foveation level control module, where the foveation level control module may be configured to wait for a programmable/configurable number of consecutive frames with consistent decision before changing levels of foveation. For example, if the estimated detail level is greater than the detail level threshold (D>detail level threshold or D>threshold_high) for more than X frames (e.g., X=15, 30, etc.), the foveation level control module may switch to a higher level of foveation if it is currently using a lower level of foveation. Similarly, if the estimated detail level is less than the detail level threshold (D<detail level threshold or D<threshold_low) for more than X frames, the foveation level control module may switch to a lower level of foveation if it is currently using a higher level of foveation.

In another aspect of the present disclosure, the foveation level control module may be configured to adjust the weight map and/or the detail level threshold(s) discussed in connection with FIGS. 10A, 10B, and 11 based on the scene. For example, based on the lighting condition of a scene, different vision types in human vision system (HVS) may be activated and hence the foveation level control module may adjust/modify the detail level threshold(s) and/or the weight map based on the lux levels of the scene. Examples of vision types of HVS based on lux levels may include: (1) photopic vision in bright and/or normal light where most of vision activity is by cones, where cone density may be higher in the center and fall rapidly from the center; (2) mesopic vision in dark light where vision activity is by combination of rods and cones, and rod density is higher in the peripheral regions and hence acuity fall off may not be as rapid (as such higher weights may be given to the periphery to account for contribution to vision from rods); and/or (3) scotopic vision in very low light conditions which may be mostly achieved by rods (e.g., as rods density may be higher in the periphery, more weights may be given to the periphery to be more conservative about switching to lower levels of foveation).

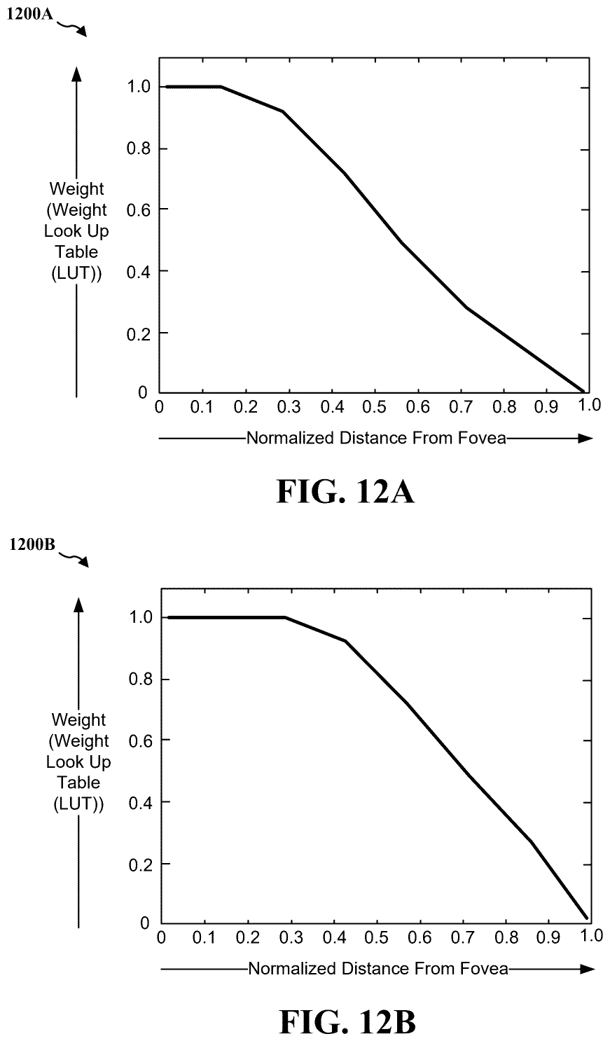

FIG. 12A is a diagram 1200A illustrating an example weight versus (vs) distance plot for normal/bright lighting in accordance with various aspects of the present disclosure. FIG. 12B is a diagram 1200B illustrating an example weight versus (vs) distance plot for scotopic vision in accordance with various aspects of the present disclosure. As observed in the diagram 1200B, the foveation level control module may be configured to assign relatively higher weight for the periphery under the scotopic vision as compared to under the normal/bright lighting.

In another example, the foveation level control module may be configured to adjust the weight map and/or the detail level threshold(s) based on the head/eye movement and focus state of the system. For example, during a head/eye movement, a scene may become out of focus and hence the estimated level of details may be affected. Thus, the foveation level control module may be configured to adjust the detail level thresholds and/or the weight map based on inputs from eye-tracking/IMU-sensors and the focus state of system (e.g., in the case of movement or out of focus state, the foveation level control module may lower the thresholds. As such, weight map calculation may be modified based on lighting conditions, a head/eye movement, and/or a focus state of system (e.g., the XR headset) to accurately represent the properties of HVS. Also, in the case of scotopic vision (e.g., very low light), the weight map may be modified such that weight fall off with increasing distance from fovea center is not rapid and thus is closer to acuity fall off observed in the HVS for such lighting conditions. In some examples, when a user moves his/her head, a focus state or an auto focus (AF) state may be used to indicate a different level (e.g., a lower level) sharpness, such that the XR headset may configure its (foveation) thresholds accordingly.

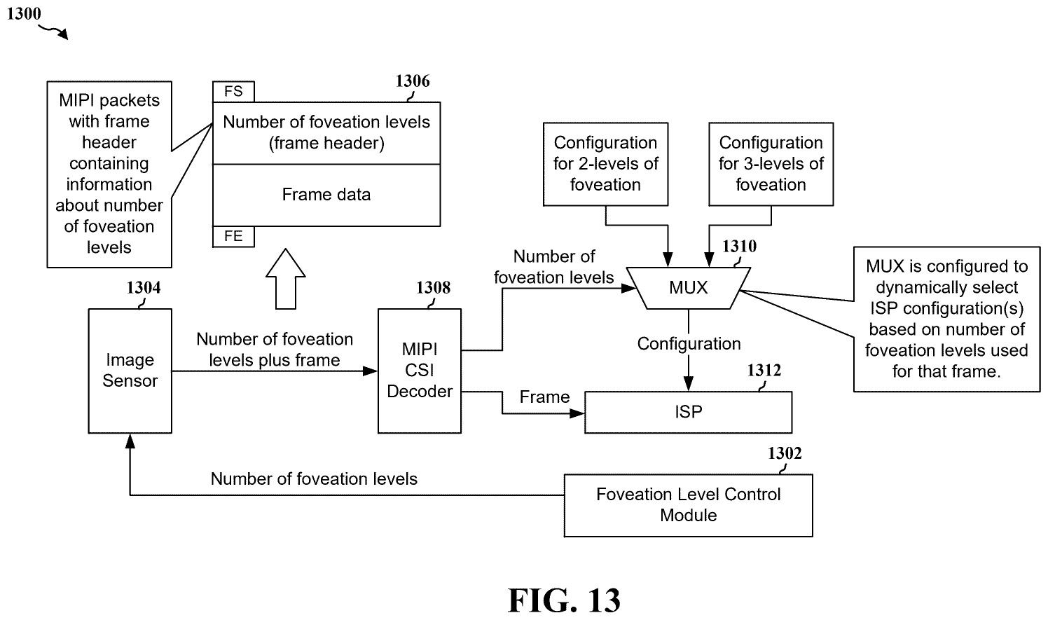

FIG. 13 is a diagram 1300 illustrating an example dataflow of maintaining a complete synchronization between a sensor and an ISP of an XR headset in accordance with various aspects of the present disclosure. In another aspect of the present disclosure, for improving the overall performance of an XR headset (e.g., the foveated sensor discussed in connection at 706 of FIG. 7), the XR headset may be configured to maintain complete synchronization between at least one sensor and at least one ISP while changing/modifying the number of foveation levels dynamically.

As shown at 1302, the foveation level control module may send the estimated number of foveation level(s) to at least one sensor (e.g., at least one image sensor such as at least one camera) as described in connection with FIG. 7. As shown at 1304, the at least one sensor may send each frame to a mobile industry processor interface (MIPI) camera serial interface (CSI) decoder with a header containing information related to the number of foveation level used for that frame as shown at 1306 (which may be referred to as a “MIPI packet.” As shown at 1308, the MIPI CSI decoder may decode the MIPI packets from the at least one sensor, and then pass the information related to the number of foveation level for a frame to a multiplexer (MUX). As shown at 1310, the MUX may be configured to select the configuration to be used by an ISP based on the number of foveation level for a frame, and transmit the configuration to the ISP. Then, as shown at 1312, the ISP may process the frame from the MIPI CSI decoder and the configuration from the MUX. Such configuration may ensure that there are no frame-drops (e.g., as the at least one sensor and the ISP are (always) in synchronization), and the foveation level may be updated (e.g., by the XR headset or the foveation level control module) in the next frame itself with no latency. The foveation level may also be sent to a display processing unit (DPU), and a display associated with the DPU may be configured to output the images/videos with the foveation level.

Sensor and ISP foveation is used in XR to reduce power and meet increasing demand for resolution/FPS in VST. Two and three levels of foveation have been used to provide a gradual change in resolution as the user moves from the fovea region. Three levels of foveation consumes more power and bandwidth as compared to the two levels of foveation. Currently, the number of foveation levels is fixed by OEMs based on IQ versus power-trade-off. There is a desire to dynamically determine the number of foveation levels sufficient for a particular scene and switch it accordingly. Information from an ISP or Saliency map are calculated to extract details present in the periphery, and based on the level of details in the periphery, a determination is made whether two foveation levels are sufficient for maintaining IQ or whether three foveation levels are specified. Contrast/sharpness/brightness statistics and/or saliency detection statistics are used to estimate levels of details present in the periphery.

Aspects presented herein may improve the overall performance of XR headsets. Aspects presented herein may enable an XR headset (or its component(s)/processor(s)) to use contrast/sharpness/brightness statistics and/or a saliency map to estimate the level of details specified in the periphery (of at least one display) and determine the number of foveation levels specified for the periphery (or the display). The XR headset (or its component(s)/processor(s)) may perform the weight map and the threshold adjustment based on lighting conditions, eye/head movement and/or focus state of system. Aspects presented herein also provide a dataflow to ensure a complete sensor-ISP synchronization and no frame-drops and no latency when dynamically changing number of foveation levels. Aspects presented here may provide power, bandwidth, and computing resource optimization for VST use-cases based on the scene-content without impact to the perceptual IQ.

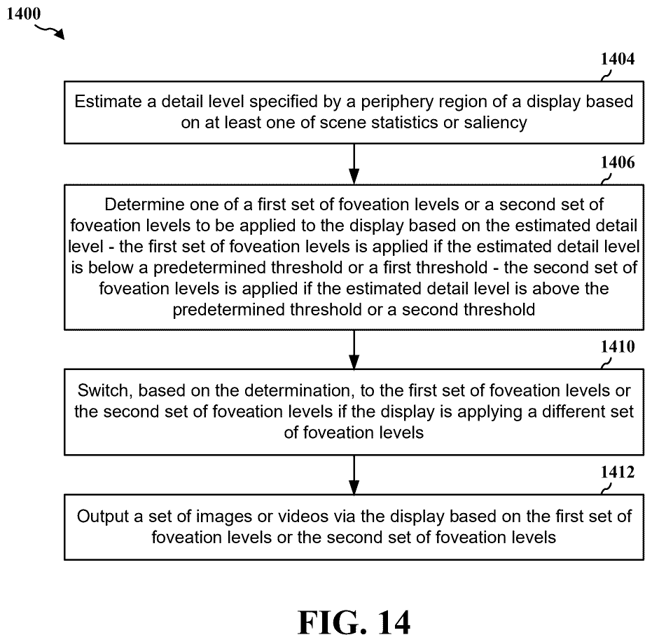

FIG. 14 is a flowchart 1400 of a method of image processing at a user equipment (UE). The method may be performed by a UE (e.g., the UE 104; the XR headset 502, 720, 820; the apparatus 1604). The method may enable the UE to use statistics and/or a saliency map to estimate the level of details specified in the periphery (of at least one display) and determine the number of foveation levels specified for the periphery (or the display), thereby improving the overall performance of the UE.

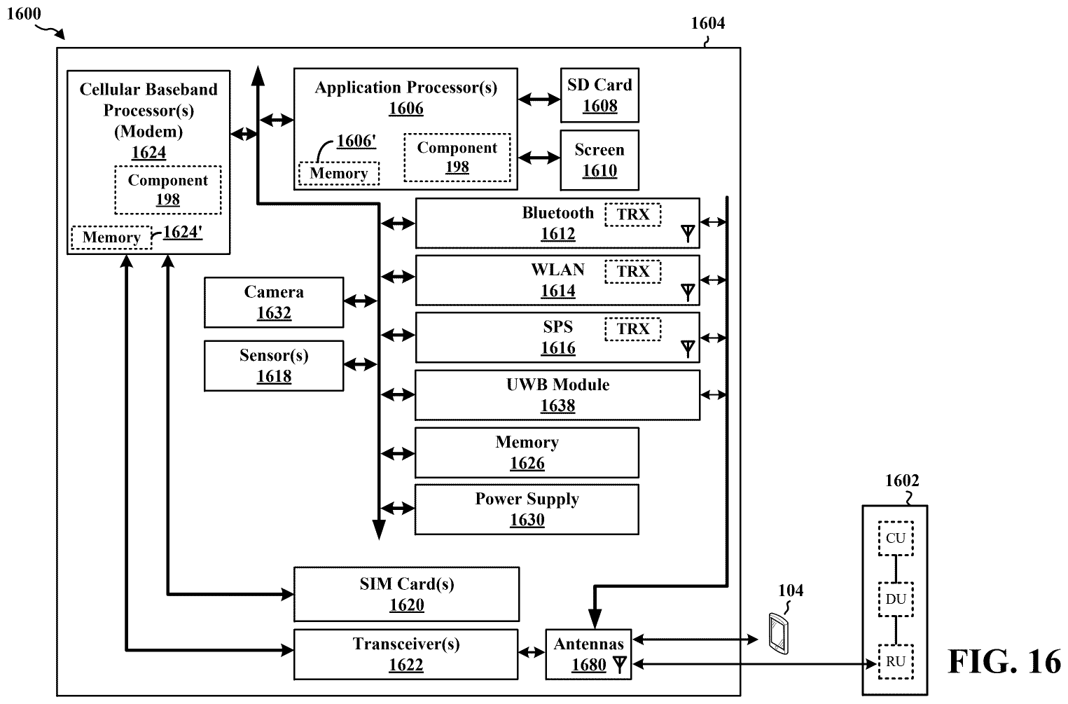

At 1404, the UE may estimate a detail level specified by a periphery region of a display based on at least one of scene statistics or saliency, such as described in connection with FIGS. 7 to 9. For example, as discussed in connection with 902 of FIG. 9, after the foveation level control module described in connection with FIGS. 7 and 8 receives (1) fovea region location(s), (2) aux-camera data related to eye tracking, (3) IMU data related to head tracking, (4) a set of scene statistics, and (5) a saliency map from various modules, the foveation level control module may estimate the detail level specified for the peripheral region as shown by FIG. 6. The estimation of the detail level may be performed by, e.g., the foveation switching component 198, the screen 1610, the one or more sensors 1618, the camera 1632, the transceiver(s) 1622, the cellular baseband processor(s) 1624, and/or the application processor(s) 1606 of the apparatus 1604 in FIG. 16.

At 1406, the UE may determine one of a first set of foveation levels or a second set of foveation levels to be applied to the display based on the estimated detail level, where the first set of foveation levels is applied if the estimated detail level is below a predetermined threshold or a first threshold, where the second set of foveation levels is applied if the estimated detail level is above the predetermined threshold or a second threshold, such as described in connection with FIGS. 7 to 9. For example, as discussed in connection with 702 of FIG. 7, a foveation level control module may be configured to determine the number of foveation levels specified by one or more displays (or specified by one or more frames to be output by the one or more displays) of an XR headset 720 based on a set of inputs, such as: (1) fovea region location(s) (e.g., obtained from a fovea detection module based on gaze detection and/or gyro tracking, etc. as shown at 704), (2) auxiliary (aux)-camera data related to eye tracking, (3) IMU data related to head tracking, (4) a set of scene statistics (stats) (e.g., obtained from an ISP at a front end), and (5) a saliency map (e.g., obtained from a saliency detection module). The determine of the one of the first set of foveation levels or the second set of foveation levels to be applied to the display may be performed by, e.g., the foveation switching component 198, the screen 1610, the one or more sensors 1618, the camera 1632, the transceiver(s) 1622, the cellular baseband processor(s) 1624, and/or the application processor(s) 1606 of the apparatus 1604 in FIG. 16.

At 1410, the UE may switch, based on the determination, to the first set of foveation levels or the second set of foveation levels if the display is applying a different set of foveation levels, such as described in connection with FIGS. 7 to 9. For example, as discussed in connection with 904 of FIG. 9, based on the extracted/identified level of details in the periphery, the foveation level control module may decide whether current level of foveation used by the XR headset is sufficient to maintaining the image quality (IQ) and/or whether a higher/lower of foveation is specified to improve the IQ or the power consumption. For example, assuming that the XR headset supports both the two-levels of foveation and three-levels of foveation as described in connection with FIG. 6, there may be four possible cases. First, if three-levels of foveation are currently being used and the extracted/identified level of details in the periphery is less (e.g., below a detail level threshold), the foveation level control module may decide to switch to two-levels of foveation (e.g., to improve power consumption). Second, if three-levels of foveation are currently being used and the extracted/identified level of details in the periphery is high (e.g., above a detail level threshold), the foveation level control module may decide to stick to/maintain three-levels of foveation. Third, if two-levels of foveation are currently being used and the extracted/identified level of details in the periphery is less (e.g., below a detail level threshold), the foveation level control module may decide to stick to/maintain two-levels of foveation. Fourth, if two-levels of foveation are currently being used and the extracted/identified level of details in the periphery is high (e.g., above a detail level threshold), the foveation level control module may decide to switch to three-levels of foveation (e.g., to improve IQ). The switch to the first set of foveation levels or the second set of foveation levels may be performed by, e.g., the foveation switching component 198, the screen 1610, the one or more sensors 1618, the camera 1632, the transceiver(s) 1622, the cellular baseband processor(s) 1624, and/or the application processor(s) 1606 of the apparatus 1604 in FIG. 16.

At 1412, the UE may output a set of images or videos via the display based on the first set of foveation levels or the second set of foveation levels, such as described in connection with FIGS. 7 to 9. For example, as discussed in connection with 714 of FIG. 7, the XR headset 720 may apply the determined number of foveation levels to one or more of its displays, such as to a set of images or videos. The output of the second set of images or videos may be performed by, e.g., the foveation switching component 198, the screen 1610, the one or more sensors 1618, the camera 1632, the transceiver(s) 1622, the cellular baseband processor(s) 1624, and/or the application processor(s) 1606 of the apparatus 1604 in FIG. 16.

In one example, the UE may select or generate a weight map for the periphery region of the display, where to estimate the detail level specified by the periphery region of the display based on at least one of the scene statistics or the saliency, the UE may be configured to calculate a weighted sum of at least one of the scene statistics or the saliency to obtain a value indicating the detail level, such as described in connection with FIGS. 7, 9, 10A, and 10B. For example, as discussed in connection with FIG. 10A, a black and white image may be configured to show how weights are distributed throughout an image based on the location of the fovea, where the weights may range from zero (e.g., for black) to one (e.g., for white). The selection or generation of the weight map may be performed by, e.g., the foveation switching component 198, the screen 1610, the one or more sensors 1618, the camera 1632, the transceiver(s) 1622, the cellular baseband processor(s) 1624, and/or the application processor(s) 1606 of the apparatus 1604 in FIG. 16. In some implementations, the UE may configure or modify the weight map based on at least one of a lighting condition, a head movement, an eye movement, or a focus state.

In another example, the UE may configure or modify the predetermined threshold, the first threshold, or the second threshold based on at least one of a lighting condition, a head movement, an eye movement, or a focus state. For example, as discussed above, the foveation level control module may be configured to adjust the weight map and/or the detail level threshold(s) based on the head/eye movement and focus state of the system. For example, during a head/eye movement, a scene may become out of focus and hence the estimated level of details may be affected. Thus, the foveation level control module may be configured to adjust the detail level thresholds and/or the weight map based on inputs from eye-tracking/IMU-sensors and the focus state of system (e.g., in the case of movement or out of focus state, the foveation level control module may lower the thresholds. The configuration or the modification of the predetermined threshold may be performed by, e.g., the foveation switching component 198, the screen 1610, the one or more sensors 1618, the camera 1632, the transceiver(s) 1622, the cellular baseband processor(s) 1624, and/or the application processor(s) 1606 of the apparatus 1604 in FIG. 16.

In another example, the first set of foveation levels includes two levels of foveation and the second set of foveation levels includes three levels of foveation.

In another example, to switch to the first set of foveation levels or the second set of foveation levels if the display is applying the different set of foveation levels, the UE may be configured to switch to the first set of foveation levels if the display is currently applying the second set of foveation levels or a third set of foveation levels, or switch to the second set of foveation levels if the display is currently applying the first set of foveation levels or the third set of foveation levels.

In another example, the estimation of the detail level specified by the periphery region of the display is further based on at least one of: auxiliary camera data for eye tracking, inertial measurement unit (IMU) data for head tracking, or a fovea location.

In another example, to estimate the detail level specified by the periphery region of the display based on the scene statistics, the UE may be configured to estimate the detail level specified by the periphery region of the display based on at least one of contrast, sharpness, or brightness statistics.

In another example, the second threshold is higher than the first threshold.

In another example, to estimate the detail level specified by the periphery region of the display the UE may be configured to estimate the detail level specified by the periphery region of the display in a number of consecutive frames, and to output the second set of images or videos via the display based on the second set of foveation levels if the estimated detail level is above or below the detail threshold the UE may be configured to output the second set of images or videos via the display based on the second set of foveation levels if the estimated detail level is above or below the detail threshold for the number of consecutive frames.

In another example, the UE is a head-mounted display that is capable of providing virtual reality (VR) content, augmented reality (AR) content, or extended reality (XR) content via the display.

In another example, to output the set of images or videos via the display based on the first set of foveation levels or the second set of foveation levels, the UE may be configured to transmit, to at least one sensor, an indication of the first set of foveation levels or the second set of foveation levels, receive, from a multiplexer (MUX), a configuration for the first set of foveation levels or the second set of foveation levels, and apply the configuration to an image signal processor (ISP). In some implementations, the UE may transmit the indication to a display processing unit (DPU) for outputting the set of images or videos with the first set of foveation levels or the second set of foveation levels via the display.

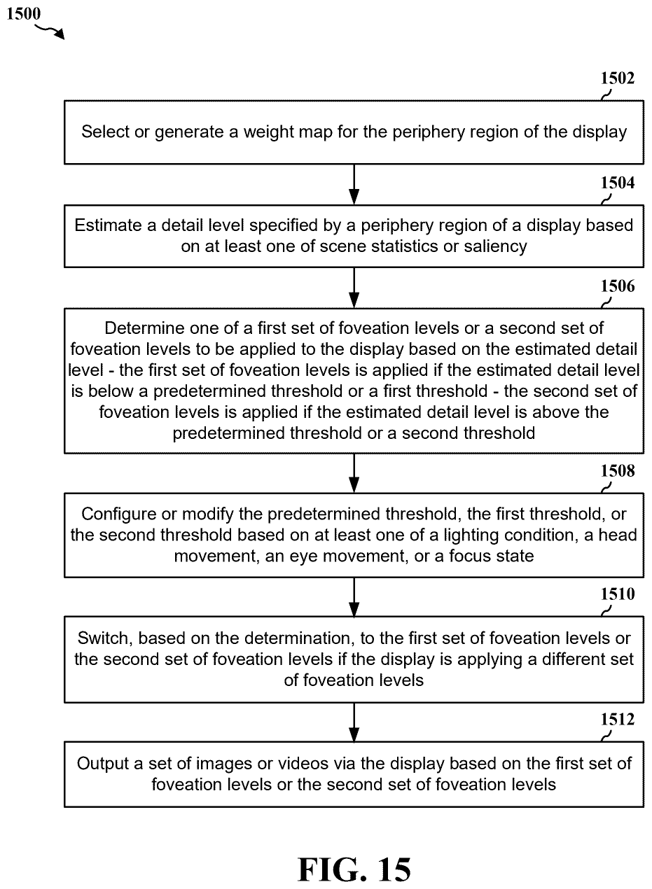

FIG. 15 is a flowchart 1500 of a method of image processing at a user equipment (UE). The method may be performed by a UE (e.g., the UE 104; the XR headset 502, 720, 820; the apparatus 1604). The method may enable the UE to use statistics and/or a saliency map to estimate the level of details specified in the periphery (of at least one display) and determine the number of foveation levels specified for the periphery (or the display), thereby improving the overall performance of the UE.

At 1504, the UE may estimate a detail level specified by a periphery region of a display based on at least one of scene statistics or saliency, such as described in connection with FIGS. 7 to 9. For example, as discussed in connection with 902 of FIG. 9, after the foveation level control module described in connection with FIGS. 7 and 8 receives (1) fovea region location(s), (2) aux-camera data related to eye tracking, (3) IMU data related to head tracking, (4) a set of scene statistics, and (5) a saliency map from various modules, the foveation level control module may estimate the detail level specified for the peripheral region as shown by FIG. 6. The estimation of the detail level may be performed by, e.g., the foveation switching component 198, the screen 1610, the one or more sensors 1618, the camera 1632, the transceiver(s) 1622, the cellular baseband processor(s) 1624, and/or the application processor(s) 1606 of the apparatus 1604 in FIG. 16.

At 1506, the UE may determine one of a first set of foveation levels or a second set of foveation levels to be applied to the display based on the estimated detail level, where the first set of foveation levels is applied if the estimated detail level is below a predetermined threshold or a first threshold, where the second set of foveation levels is applied if the estimated detail level is above the predetermined threshold or a second threshold, such as described in connection with FIGS. 7 to 9. For example, as discussed in connection with 702 of FIG. 7, a foveation level control module may be configured to determine the number of foveation levels specified by one or more displays (or specified by one or more frames to be output by the one or more displays) of an XR headset 720 based on a set of inputs, such as: (1) fovea region location(s) (e.g., obtained from a fovea detection module based on gaze detection and/or gyro tracking, etc. as shown at 704), (2) auxiliary (aux)-camera data related to eye tracking, (3) IMU data related to head tracking, (4) a set of scene statistics (stats) (e.g., obtained from an ISP at a front end), and (5) a saliency map (e.g., obtained from a saliency detection module). The determine of the one of the first set of foveation levels or the second set of foveation levels to be applied to the display may be performed by, e.g., the foveation switching component 198, the screen 1610, the one or more sensors 1618, the camera 1632, the transceiver(s) 1622, the cellular baseband processor(s) 1624, and/or the application processor(s) 1606 of the apparatus 1604 in FIG. 16.

At 1510, the UE may switch, based on the determination, to the first set of foveation levels or the second set of foveation levels if the display is applying a different set of foveation levels, such as described in connection with FIGS. 7 to 9. For example, as discussed in connection with 904 of FIG. 9, based on the extracted/identified level of details in the periphery, the foveation level control module may decide whether current level of foveation used by the XR headset is sufficient to maintaining the IQ and/or whether a higher/lower of foveation is specified to improve the IQ or the power consumption. For example, assuming that the XR headset supports both the two-levels of foveation and three-levels of foveation as described in connection with FIG. 6, there may be four possible cases. First, if three-levels of foveation are currently being used and the extracted/identified level of details in the periphery is less (e.g., below a detail level threshold), the foveation level control module may decide to switch to two-levels of foveation (e.g., to improve power consumption). Second, if three-levels of foveation are currently being used and the extracted/identified level of details in the periphery is high (e.g., above a detail level threshold), the foveation level control module may decide to stick to/maintain three-levels of foveation. Third, if two-levels of foveation are currently being used and the extracted/identified level of details in the periphery is less (e.g., below a detail level threshold), the foveation level control module may decide to stick to/maintain two-levels of foveation. Fourth, if two-levels of foveation are currently being used and the extracted/identified level of details in the periphery is high (e.g., above a detail level threshold), the foveation level control module may decide to switch to three-levels of foveation (e.g., to improve IQ). The switch to the first set of foveation levels or the second set of foveation levels may be performed by, e.g., the foveation switching component 198, the screen 1610, the one or more sensors 1618, the camera 1632, the transceiver(s) 1622, the cellular baseband processor(s) 1624, and/or the application processor(s) 1606 of the apparatus 1604 in FIG. 16.

At 1512, the UE may output a set of images or videos via the display based on the first set of foveation levels or the second set of foveation levels, such as described in connection with FIGS. 7 to 9. For example, as discussed in connection with 714 of FIG. 7, the XR headset 720 may apply the determined number of foveation levels to one or more of its displays, such as to a set of images or videos. The output of the second set of images or videos may be performed by, e.g., the foveation switching component 198, the screen 1610, the one or more sensors 1618, the camera 1632, the transceiver(s) 1622, the cellular baseband processor(s) 1624, and/or the application processor(s) 1606 of the apparatus 1604 in FIG. 16.

In one example, as shown at 1502, the UE may select or generate a weight map for the periphery region of the display, where to estimate the detail level specified by the periphery region of the display based on at least one of the scene statistics or the saliency, the UE may be configured to calculate a weighted sum of at least one of the scene statistics or the saliency to obtain a value indicating the detail level, such as described in connection with FIGS. 7, 9, 10A, and 10B. For example, as discussed in connection with FIG. 10A, a black and white image may be configured to show how weights are distributed throughout an image based on the location of the fovea, where the weights may range from zero (e.g., for black) to one (e.g., for white). The selection or generation of the weight map may be performed by, e.g., the foveation switching component 198, the screen 1610, the one or more sensors 1618, the camera 1632, the transceiver(s) 1622, the cellular baseband processor(s) 1624, and/or the application processor(s) 1606 of the apparatus 1604 in FIG. 16. In some implementations, the UE may configure or modify the weight map based on at least one of a lighting condition, a head movement, an eye movement, or a focus state.

In another example, as shown at 1508, the UE may configure or modify the predetermined threshold, the first threshold, or the second threshold based on at least one of a lighting condition, a head movement, an eye movement, or a focus state. For example, as discussed above, the foveation level control module may be configured to adjust the weight map and/or the detail level threshold(s) based on the head/eye movement and focus state of the system. For example, during a head/eye movement, a scene may become out of focus and hence the estimated level of details may be affected. Thus, the foveation level control module may be configured to adjust the detail level thresholds and/or the weight map based on inputs from eye-tracking/IMU-sensors and the focus state of system (e.g., in the case of movement or out of focus state, the foveation level control module may lower the thresholds. The configuration or the modification of the predetermined threshold may be performed by, e.g., the foveation switching component 198, the screen 1610, the one or more sensors 1618, the camera 1632, the transceiver(s) 1622, the cellular baseband processor(s) 1624, and/or the application processor(s) 1606 of the apparatus 1604 in FIG. 16.

In another example, the first set of foveation levels includes two levels of foveation and the second set of foveation levels includes three levels of foveation.

In another example, to switch to the first set of foveation levels or the second set of foveation levels if the display is applying the different set of foveation levels, the UE may be configured to switch to the first set of foveation levels if the display is currently applying the second set of foveation levels or a third set of foveation levels, or switch to the second set of foveation levels if the display is currently applying the first set of foveation levels or the third set of foveation levels.

In another example, the estimation of the detail level specified by the periphery region of the display is further based on at least one of: auxiliary camera data for eye tracking, IMU data for head tracking, or a fovea location.

In another example, to estimate the detail level specified by the periphery region of the display based on the scene statistics, the UE may be configured to estimate the detail level specified by the periphery region of the display based on at least one of contrast, sharpness, or brightness statistics.

In another example, the second threshold is higher than the first threshold.

In another example, to estimate the detail level specified by the periphery region of the display the UE may be configured to estimate the detail level specified by the periphery region of the display in a number of consecutive frames, and to output the second set of images or videos via the display based on the second set of foveation levels if the estimated detail level is above or below the detail threshold the UE may be configured to output the second set of images or videos via the display based on the second set of foveation levels if the estimated detail level is above or below the detail threshold for the number of consecutive frames.

In another example, the UE is a head-mounted display that is capable of providing VR content, AR content, or XR content via the display.

In another example, to output the set of images or videos via the display based on the first set of foveation levels or the second set of foveation levels, the UE may be configured to transmit, to at least one sensor, an indication of the first set of foveation levels or the second set of foveation levels, receive, from a MUX, a configuration for the first set of foveation levels or the second set of foveation levels, and apply the configuration to an ISP. In some implementations, the UE may transmit the indication to a DPU for outputting the set of images or videos with the first set of foveation levels or the second set of foveation levels via the display.

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include at least one cellular baseband processor 1624 (also referred to as a modem) coupled to one or more transceivers 1622 (e.g., cellular RF transceiver). The cellular baseband processor(s) 1624 may include at least one on-chip memory 1624′. In some aspects, the apparatus 1604 may further include one or more subscriber identity modules (SIM) cards 1620 and at least one application processor 1606 coupled to a secure digital (SD) card 1608 and a screen 1610. The application processor(s) 1606 may include on-chip memory 1606′. In some aspects, the apparatus 1604 may further include a Bluetooth module 1612, a WLAN module 1614, an ultrawide band (UWB) module 1638, an SPS module 1616 (e.g., GNSS module), one or more sensors 1618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the UWB module 1638, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor(s) 1624 communicates through the transceiver(s) 1622 via one or more antennas 1680 with the UE 104 and/or with an RU associated with a network entity 1602. The cellular baseband processor(s) 1624 and the application processor(s) 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor(s) 1624 and the application processor(s) 1606 are each responsible for general processing, including the execution of software stored on the computer-readable medium/memory. The software, when executed by the cellular baseband processor(s) 1624/application processor(s) 1606, causes the cellular baseband processor(s) 1624/application processor(s) 1606 to perform the various functions described supra. The cellular baseband processor(s) 1624 and the application processor(s) 1606 are configured to perform the various functions described supra based at least in part of the information stored in the memory. That is, the cellular baseband processor(s) 1624 and the application processor(s) 1606 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1624/application processor(s) 1606 when executing software. The cellular baseband processor(s) 1624/application processor(s) 1606 may be a component of the UE 350 and may include the at least one memory 360 and/or at least one of the TX processor 368, the RX processor 356, and the controller/processor 359. In one configuration, the apparatus 1604 may be at least one processor chip (modem and/or application) and include just the cellular baseband processor(s) 1624 and/or the application processor(s) 1606, and in another configuration, the apparatus 1604 may be the entire UE (e.g., see UE 350 of FIG. 3) and include the additional modules of the apparatus 1604.

As discussed supra, the foveation switching component 198 may be configured to estimate a detail level specified by a periphery region of a display based on at least one of scene statistics or saliency. The foveation switching component 198 may also be configured to determine one of a first set of foveation levels or a second set of foveation levels to be applied to the display based on the estimated detail level, where the first set of foveation levels is applied if the estimated detail level is below a predetermined threshold or a first threshold, where the second set of foveation levels is applied if the estimated detail level is above the predetermined threshold or a second threshold. The foveation switching component 198 may also be configured to switch, based on the determination, to the first set of foveation levels or the second set of foveation levels if the display is applying a different set of foveation levels. The foveation switching component 198 may also be configured to output a set of images or videos via the display based on the first set of foveation levels or the second set of foveation levels. The foveation switching component 198 may be within the cellular baseband processor(s) 1624, the application processor(s) 1606, or both the cellular baseband processor(s) 1624 and the application processor(s) 1606. The foveation switching component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1604 may include a variety of components configured for various functions. In one configuration, the apparatus 1604, and in particular the cellular baseband processor(s) 1624 and/or the application processor(s) 1606, may include means for estimating a detail level specified by a periphery region of a display based on at least one of scene statistics or saliency. The apparatus 1604 may further include means for determining one of a first set of foveation levels or a second set of foveation levels to be applied to the display based on the estimated detail level, where the first set of foveation levels is applied if the estimated detail level is below a predetermined threshold or a first threshold, where the second set of foveation levels is applied if the estimated detail level is above the predetermined threshold or a second threshold. The apparatus 1604 may further include means for switching, based on the determination, to the first set of foveation levels or the second set of foveation levels if the display is applying a different set of foveation levels. The apparatus 1604 may further include means for outputting a set of images or videos via the display based on the first set of foveation levels or the second set of foveation levels.

In one configuration, the apparatus 1604 may further include means for selecting or means for generating a weight map for the periphery region of the display, where the means for estimating the detail level specified by the periphery region of the display based on at least one of the scene statistics or the saliency may include configuring the apparatus 1604 to calculate a weighted sum of at least one of the scene statistics or the saliency to obtain a value indicating the detail level. In some implementations, the apparatus 1604 may further include means for configuring or means for modifying the weight map based on at least one of a lighting condition, a head movement, an eye movement, or a focus state.

In another configuration, the apparatus 1604 may further include means for configuring or means for modifying the predetermined threshold, the first threshold, or the second threshold based on at least one of a lighting condition, a head movement, an eye movement, or a focus state.

In another configuration, the first set of foveation levels includes two levels of foveation and the second set of foveation levels includes three levels of foveation.

In another configuration, the means for switching to the first set of foveation levels or the second set of foveation levels if the display is applying the different set of foveation levels may include configuring the apparatus 1604 to switch to the first set of foveation levels if the display is currently applying the second set of foveation levels or a third set of foveation levels, or switch to the second set of foveation levels if the display is currently applying the first set of foveation levels or the third set of foveation levels.

In another configuration, the estimation of the detail level specified by the periphery region of the display is further based on at least one of: auxiliary camera data for eye tracking, IMU data for head tracking, or a fovea location.

In another configuration, to estimate the detail level specified by the periphery region of the display based on the scene statistics, the UE may be configured to estimate the detail level specified by the periphery region of the display based on at least one of contrast, sharpness, or brightness statistics.

In another configuration, the second threshold is higher than the first threshold.

In another configuration, the means for estimating the detail level specified by the periphery region of the display may include configuring the apparatus 1604 to estimate the detail level specified by the periphery region of the display in a number of consecutive frames, and the means for outputting the second set of images or videos via the display based on the second set of foveation levels if the estimated detail level is above or below the detail threshold may include configuring the apparatus 1604 to output the second set of images or videos via the display based on the second set of foveation levels if the estimated detail level is above or below the detail threshold for the number of consecutive frames.

In another configuration, the apparatus 1604 is a head-mounted display that is capable of providing VR content, AR content, or XR content via the display.

In another configuration, the means for outputting the set of images or videos via the display based on the first set of foveation levels or the second set of foveation levels may include configuring the apparatus 1604 to transmit, to at least one sensor, an indication of the first set of foveation levels or the second set of foveation levels, receive, from a MUX, a configuration for the first set of foveation levels or the second set of foveation levels, and apply the configuration to an ISP. In some implementations, the apparatus 1604 may further include means for transmitting the indication to a DPU for outputting the set of images or videos with the first set of foveation levels or the second set of foveation levels via the display.

The means may be the foveation switching component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of image processing, comprising: estimating a detail level specified by a periphery region of a display based on at least one of scene statistics or saliency; determining one of a first set of foveation levels or a second set of foveation levels to be applied to the display based on the estimated detail level, wherein the first set of foveation levels is applied if the estimated detail level is below a predetermined threshold or a first threshold, wherein the second set of foveation levels is applied if the estimated detail level is above the predetermined threshold or a second threshold; switching, based on the determination, to the first set of foveation levels or the second set of foveation levels if the display is applying a different set of foveation levels; and outputting a set of images or videos via the display based on the first set of foveation levels or the second set of foveation levels.

Aspect 2 is the method of aspect 1, wherein the first set of foveation levels includes two levels of foveation and the second set of foveation levels includes three levels of foveation.

Aspect 3 is the method of aspect 1 or aspect 2, wherein switching to the first set of foveation levels or the second set of foveation levels if the display is applying the different set of foveation levels comprises: switching to the first set of foveation levels if the display is currently applying the second set of foveation levels or a third set of foveation levels, or switching to the second set of foveation levels if the display is currently applying the first set of foveation levels or the third set of foveation levels.

Aspect 4 is the method of any of aspects 1 to 3, wherein the estimation of the detail level specified by the periphery region of the display is further based on at least one of: auxiliary camera data for eye tracking, inertial measurement unit (IMU) data for head tracking, or a fovea location.

Aspect 5 is the method of any of aspects 1 to 4, wherein estimating the detail level specified by the periphery region of the display based on the scene statistics comprises: estimating the detail level specified by the periphery region of the display based on at least one of contrast, sharpness, or brightness statistics.

Aspect 6 is the method of any of aspects 1 to 5, further comprising: selecting or generating a weight map for the periphery region of the display, wherein estimating the detail level specified by the periphery region of the display based on at least one of the scene statistics or the saliency comprises calculating a weighted sum of at least one of the scene statistics or the saliency to obtain a value indicating the detail level.

Aspect 7 is the method of any of aspects 1 to 6, further comprising: configuring or modifying the weight map based on at least one of a lighting condition, a head movement, an eye movement, or a focus state.

Aspect 8 is the method of any of aspects 1 to 7, wherein the second threshold is higher than the first threshold.

Aspect 9 is the method of any of aspects 1 to 8, wherein estimating the detail level specified by the periphery region of the display comprises estimating the detail level specified by the periphery region of the display in a number of consecutive frames, wherein determining one of the first set of foveation levels or the second set of foveation levels to be applied to the display based on the estimated detail level comprises determining one of the first set of foveation levels or the second set of foveation levels to be applied to the display based on the estimated detail level being above or below the predetermined threshold for the number of consecutive frames.

Aspect 10 is the method of any of aspects 1 to 9, further comprising: configuring or modifying the predetermined threshold, the first threshold, or the second threshold based on at least one of a lighting condition, a head movement, an eye movement, or a focus state.

Aspect 11 is the method of any of aspects 1 to 10, wherein the method is performed by a head-mounted display that is capable of providing virtual reality (VR) content, augmented reality (AR) content, or extended reality (XR) content via the display.

Aspect 12 is the method of any of aspects 1 to 11, wherein outputting the set of images or videos via the display based on the first set of foveation levels or the second set of foveation levels comprises: transmitting, to at least one sensor, an indication of the first set of foveation levels or the second set of foveation levels; receiving, from a multiplexer (MUX), a configuration for the first set of foveation levels or the second set of foveation levels; and applying the configuration to an image signal processor (ISP).

Aspect 13 is the method of any of aspects 1 to 12, further comprising: transmitting the indication to a display processing unit (DPU) for outputting the second set of images or videos with the second set of foveation levels via the display.

Aspect 14 is an apparatus for image processing, including: at least one memory; and at least one processor coupled to the at least one memory and, based at least in part on information stored in the at least one memory, the at least one processor, individually or in any combination, is configured to implement any of aspects 1 to 13.

Aspect 15 is the apparatus of aspect 14, further including at least one transceiver or at least one antenna coupled to the at least one processor.

Aspect 16 is an apparatus for image processing, including means for implementing any of aspects 1 to 13.

Aspect 17 is a computer-readable medium (e.g., a non-transitory computer-readable medium) storing computer executable code, where the code when executed by a processor causes the processor to implement any of aspects 1 to 13.

What is claimed is:

1. An apparatus for image processing, comprising:
at least one memory; and
at least one processor coupled to the at least one memory and, based at least in part on information stored in the at least one memory, the at least one processor, individually or in any combination, is configured to:
estimate a detail level specified by a periphery region of a display based on at least one of scene statistics or saliency;
determine one of a first set of foveation levels or a second set of foveation levels to be applied to the display based on the estimated detail level, wherein the first set of foveation levels is applied if the estimated detail level is below a predetermined threshold or a first threshold, wherein the second set of foveation levels is applied if the estimated detail level is above the predetermined threshold or a second threshold;
switch, based on the determination, to the first set of foveation levels or the second set of foveation levels if the display is applying a different set of foveation levels; and
output a set of images or videos via the display based on the first set of foveation levels or the second set of foveation levels.

2. The apparatus of claim 1, wherein the first set of foveation levels includes two levels of foveation and the second set of foveation levels includes three levels of foveation.

3. The apparatus of claim 1, wherein to switch to the first set of foveation levels or the second set of foveation levels if the display is applying the different set of foveation levels, the at least one processor, individually or in any combination, is configured to:
switch to the first set of foveation levels if the display is currently applying the second set of foveation levels or a third set of foveation levels, or switch to the second set of foveation levels if the display is currently applying the first set of foveation levels or the third set of foveation levels.

4. The apparatus of claim 1, wherein the estimation of the detail level specified by the periphery region of the display is further based on at least one of:
auxiliary camera data for eye tracking,
inertial measurement unit (IMU) data for head tracking, or
a fovea location.

5. The apparatus of claim 1, wherein to estimate the detail level specified by the periphery region of the display based on the scene statistics, the at least one processor, individually or in any combination, is configured to:
estimate the detail level specified by the periphery region of the display based on at least one of contrast, sharpness, or brightness statistics.

6. The apparatus of claim 1, wherein the at least one processor, individually or in any combination, is further configured to:
select or generate a weight map for the periphery region of the display, wherein to estimate the detail level specified by the periphery region of the display based on at least one of the scene statistics or the saliency, the at least one processor, individually or in any combination, is configured to calculate a weighted sum of at least one of the scene statistics or the saliency to obtain a value indicating the detail level.

7. The apparatus of claim 6, wherein the at least one processor, individually or in any combination, is further configured to:
configure or modify the weight map based on at least one of a lighting condition, a head movement, an eye movement, or a focus state.

8. The apparatus of claim 1, wherein the second threshold is higher than the first threshold.

9. The apparatus of claim 1, wherein to estimate the detail level specified by the periphery region of the display the at least one processor, individually or in any combination, is further configured to estimate the detail level specified by the periphery region of the display in a number of consecutive frames, wherein to determine one of the first set of foveation levels or the second set of foveation levels to be applied to the display based on the estimated detail level the at least one processor, individually or in any combination, is further configured to determine one of the first set of foveation levels or the second set of foveation levels to be applied to the display based on the estimated detail level being above or below the predetermined threshold for the number of consecutive frames.

10. The apparatus of claim 1, wherein the at least one processor, individually or in any combination, is further configured to:
configure or modify the predetermined threshold, the first threshold, or the second threshold based on at least one of a lighting condition, a head movement, an eye movement, or a focus state.

11. The apparatus of claim 1, wherein the apparatus is a head-mounted display that is capable of providing virtual reality (VR) content, augmented reality (AR) content, or extended reality (XR) content via the display.

12. The apparatus of claim 1, wherein to output the set of images or videos via the display based on the first set of foveation levels or the second set of foveation levels, the at least one processor, individually or in any combination, is configured to:
transmit, to at least one sensor, an indication of the first set of foveation levels or the second set of foveation levels;
receive, from a multiplexer (MUX), a configuration for the first set of foveation levels or the second set of foveation levels; and
apply the configuration to an image signal processor (ISP).

13. The apparatus of claim 12, wherein the at least one processor, individually or in any combination, is further configured to:
transmit the indication to a display processing unit (DPU) for outputting the set of images or videos with the first set of foveation levels or the second set of foveation levels via the display.

14. A method of image processing, comprising:
estimating a detail level specified by a periphery region of a display based on at least one of scene statistics or saliency;
determining one of a first set of foveation levels or a second set of foveation levels to be applied to the display based on the estimated detail level, wherein the first set of foveation levels is applied if the estimated detail level is below a predetermined threshold or a first threshold, wherein the second set of foveation levels is applied if the estimated detail level is above the predetermined threshold or a second threshold;
switching, based on the determination, to the first set of foveation levels or the second set of foveation levels if the display is applying a different set of foveation levels; and
outputting a set of images or videos via the display based on the first set of foveation levels or the second set of foveation levels.

15. The method of claim 14, wherein the first set of foveation levels includes two levels of foveation and the second set of foveation levels includes three levels of foveation.

16. The method of claim 14, wherein switching to the first set of foveation levels or the second set of foveation levels if the display is applying the different set of foveation levels comprises:
switching to the first set of foveation levels if the display is currently applying the second set of foveation levels or a third set of foveation levels, or switching to the second set of foveation levels if the display is currently applying the first set of foveation levels or the third set of foveation levels.

17. The method of claim 14, further comprising:
selecting or generating a weight map for the periphery region of the display, wherein estimating the detail level specified by the periphery region of the display based on at least one of the scene statistics or the saliency comprises calculating a weighted sum of at least one of the scene statistics or the saliency to obtain a value indicating the detail level.

18. The method of claim 14, further comprising:
configuring or modifying the detail threshold based on at least one of a lighting condition, a head movement, an eye movement, or a focus state.

19. The method of claim 14, wherein outputting the set of images or videos via the display based on the first set of foveation levels or the second set of foveation levels comprises:
transmitting, to at least one sensor, an indication of the first set of foveation levels or the second set of foveation levels;
receiving, from a multiplexer (MUX), a configuration for the first set of foveation levels or the second set of foveation levels; and
applying the configuration to an image signal processor (ISP).

20. A computer-readable medium storing computer executable code, the code when executed by at least one processor causes the at least one processor to:
estimate a detail level specified by a periphery region of a display based on at least one of scene statistics or saliency;
determine one of a first set of foveation levels or a second set of foveation levels to be applied to the display based on the estimated detail level, wherein the first set of foveation levels is applied if the estimated detail level is below a predetermined threshold or a first threshold, wherein the second set of foveation levels is applied if the estimated detail level is above the predetermined threshold or a second threshold;
switch, based on the determination, to the first set of foveation levels or the second set of foveation levels if the display is applying a different set of foveation levels; and
output a set of images or videos via the display based on the first set of foveation levels or the second set of foveation levels.
